(19) United States
(12) Patent Application Publication
(10) Pub. No.: US 2017/0078368 A1
(43) Pub. Date: Mar. 16, 2017

(54) PERIPHERAL IDENTIFICATION WITHIN MOBILE CONTAINER AND METHOD FOR USE THEREOF

(71) Applicant: Theodora Koullias, Staten Island, NY (US)

(72) Inventor: Theodora Koullias, Staten Island, NY (US)

(73) Assignee: Jon Lou Inc., Wilmington, DE (US)

(21) Appl. No.: 15/263,380

(22) Filed: Sep. 13, 2016

Related U.S. Application Data
(60) Provisional application No. 62/216,932, filed on Sep. 10, 2015.

(51) Int. Cl. H04L 29/08; G06F 17/30; G06N 5/04

(52) U.S. Cl. CPC H04L 67/10; G06N 5/04; H04L 67/22; G06F 17/30345

(57) ABSTRACT

A method and system for identifying peripheral objects within a mobile container is provided. The mobile container wirelessly checks for the presence of objects that have been tagged or are embedded with wireless identification capabilities. The container communicates to the user via an output which items are missing.

### CROSS REFERENCE TO RELATED APPLICATIONS

This application claims priority to and the benefit under 35 U.S.C. §119(e) to U.S. Provisional Patent Application No. 62/216,932 filed on Sep. 10, 2015, and claims the benefit of priority and is a continuation-in-part of U.S. patent application Ser. No. 14/639,771 filed on Mar. 5, 2015, which in turn claims priority to U.S. Provisional Patent Application No. 61/948,951 filed on Mar. 6, 2014, the entire content of each of which is incorporated herein by reference for all purposes.

### BACKGROUND

RFID, NFC, and other tag tracking systems have been used in the past for various applications, but not within personal mobile containers. Traditionally, the aforementioned are used for inventory tracking in large warehouses and large storage room-type applications, or for controlled access. Inventory tracking for use in a personal mobile container has not been implemented. Miniaturizing the tracking system allows for personal inventory management to be done on-the-go.

Current systems for inventory tracking and access control require a database, usually on an in-house server. This server is used to track items or people. With the advent of cloud technology and high-speed data to mobile devices, we are able to have a database wherever we have access to the Internet, further allowing for the miniaturization of the tracking system.

Additionally, it is now possible to tag selected items and accessories for tracking within a personal mobile container because tracking tags have become smaller, some even as small as a grain of rice. Coupled with adhesive or embedded within objects, tracking tags can be easily added to devices and other items to keep track of said items within the mobile carrying container. Some items and devices are already embedded with wireless identification capabilities, making identifying and tracking those items within a container even easier.

Attempts have been made to implement tracking solutions for personal items, but these solutions are visible, too bulky for small items, and/or rely on multiple users in a community adopting the technology to be able to locate a lost item.

Further, these solutions limit the tracking association to between a mobile device and item, only. When the “virtual leashes” between each item and mobile device are broken (or generally between any slave device and master device), usually over long distances where the signal strength weakens substantially, a user is notified of the missing item.

Some tracking association technologies also enable two-way communications between the master device and the slave device-tagged item. In this way, a user can also locate the master device if it is missing. This again is based on signal strength between the two linked devices.

These tracking solutions face several restraints, primarily the reliance on signal strength as the indicator of a missing item, which is not preventative or proactive. A user is usually a substantial distance away from the tracked item before receiving any notification of its missing status. In addition, the use of indiscriminate and unsystematic pinging between an “always on” master device and an “always listening” slave device also introduces waste in battery life.

Additionally, a user must inherently define the items to be tracked and actively manage the list of those items. None of the current solutions offer truly passive tracking of items based on behavioral learning of the user over time.

The main problem, however, is current solutions cannot track only within a container, but around a certain radius that includes the container.

In U.S. Pat. No. 6,331,817 by Steven Jeffrey Goldberg, an apparatus and system to track and report when an object is not near an expected location, object, or person is disclosed. The apparatus may be a specialized device specifically designed for the tracking of objects or it may be a software application running on another device such as PDA.

The tracking of items is restrained by various factors, primarily the need for a separate location transducer to output the proximity of the items being tracked. Further limitations are that: (1) local memory is needed in order for the processors to access program instructions or to store data; (2) users must define zones in which to trigger the object interrogation; and (3) users must define events tied to those zones (such as “apparatus leaving home zone”) as well as features of those events (time of day, day of week, etc.) for which an interrogation of a list of items is triggered.

Even in this disclosure, tracking is still limited to that between the device and the items, with the added burden that the item check is initiated by external loci which necessarily need location transducers and active user input.

There is a need for a solution that can proactively identify, manage, and track multiple objects within a mobile container without the need for a mobile device/apparatus, active user input, and/or high power consumption, and is independent of signal strength between the objects, externally located check triggers, periodic and indiscriminate interrogation, and local memory.

### BRIEF SUMMARY OF THE INVENTION

Under one aspect of the invention, a system for peripheral identification within a mobile container and a method for use thereof is presented. In one embodiment, the invention includes a device coupled within a mobile container. The device itself is comprised of a power supply, controller, sensor, and communications module. The communications module itself is comprised of a network transceiver, a reader-antenna system that reads information from electronic tags on peripheral items, and a display module that presents resultant information. The transceiver bi-directionally communicates with the controller and database on a remote server to identify the peripheral items after a signal input received by the sensor.

In another embodiment, the reader-antenna system may be an active reader querying passive electronic tracking tags.

In yet another embodiment, the electronic tags may be active tracking tags.

In still another embodiment, the reader-antenna system may query peripheral items that are embedded with wireless identification and communication technologies such as Bluetooth LE, 4G/5G, or WiFi.

In another embodiment, the transceiver may query peripheral items that are embedded with wireless identification and communication technologies such as Bluetooth LE, 4G/5G, or WiFi.

In some embodiments, the reader-antenna system may be triggered to query the peripheral items via a signal input.

In some embodiments, the signal input may be a sensor that triggers the reader-antenna system to query the peripheral items.

In other embodiments, the sensor may be a motion detector, such as an accelerometer.

In yet other embodiments, the signal input may be a message sourced from the remote database server.

In some embodiments, the message may be facilitated via a human-computer interface.

In some embodiments, the reader-antenna system may receive an identifier token from each of the queried peripheral items.

In some embodiments, the integrated controller may be a CPU, MPU, or MCU, and process information received via any and all integrated technologies

In some embodiments, the transceiver may be a wireless communications technology such as Bluetooth, 4G/5G, or WiFi.

In some embodiments, the transceiver may facilitate communication between any and all integrated technologies.

In some embodiments, the transceiver may facilitate communication between the device coupled with the container and the remote server.

In another embodiment, a mobile device may facilitate communication between the device coupled with the container and the remote server.

In some embodiments, the database residing on the remote server contains identification data of the electronic tags.

In other embodiments, the database contains identification data of the items embedded with wireless identification and communication technologies.

In yet other embodiments the database contains identification data on the container.

In some embodiments, the transceiver may transfer identifier tokens from queried peripheral items to the database on the remote server.

In other embodiments, the transceiver may transfer the container identifier to the database on the remote server.

In yet other embodiments, the transceiver may transfer the identifier tokens from the queried peripheral items in tandem with the container identifier to the database on the remote server.

In some embodiments, the transceiver may transfer an alert when the transferred tokens from the queried peripheral items cannot be identified by the information on the database on the remote server.

In another aspect of the invention, the method may include the capacity for the database to store any and all information regarding the device.

In some embodiments, the database record may be updated via the communications network.

In other embodiments, the database may be updated with the stored information, such as a user's behavioral information.

In yet other embodiments, the database may be actively updated via a human-computer interface.

In some embodiments, updates to the database may include the informational content of the database record.

In some embodiments, revisions to the database record may alter the association or disassociation of a peripheral items to the container.

In another embodiment, a predictive algorithm may be applied to the database to generate recommendations.

In other embodiments, the recommendations may be a contents list for the container.

In some embodiments, a display module or mobile device may generate, transmit, and present the information resulting from actions completed by the device.

In other embodiments, the actions completed by the device may include a peripheral check, an alteration to the database, and any alerts.

In some embodiments, the database may be preloaded with information.

In other embodiments, the preloaded information may include information from another container or previous associations.

Any of the aspects or features of the embodiments set forth herein can be combined with any other aspects or embodiments.

### BRIEF DESCRIPTION OF THE DRAWINGS

FIG. 1 is a block diagram of a mobile container system, peripheral items, and a remote database server, in accordance with some embodiments.

FIG. 2a is a block diagram exemplifying a device solution to facilitate peripheral tracking within a mobile container, in accordance with some embodiments.

FIG. 2b is a block diagram exemplifying an alternative device solution to facilitate peripheral tracking within a mobile container, in accordance with some embodiments.

FIG. 3a is a block diagram illustrating how a mobile container system is triggered to initiate a peripheral check, in accordance with some embodiments.

FIG. 3b is a block diagram of a mobile container system communicating with a remote database server, in accordance with some embodiments.

FIG. 3c is a block diagram of a remote database server communicating updates to the mobile container system, in accordance with some embodiments.

FIG. 3d is a block diagram of exemplifying how the database may be updated, in accordance with some embodiments.

FIG. 4a is a flowchart illustrating the methodology for initiating a peripheral check within a mobile container.

FIG. 4b is a flowchart exemplifying a set of conditions for peripheral tracking in a mobile container.

FIG. 4c is a flowchart exemplifying a specific set of conditions for peripheral tracking in a mobile container

FIG. 4d is a flowchart exemplifying yet another specific set of conditions for peripheral tracking in a mobile container.

FIG. 4e is a flowchart illustrating the peripheral check within a mobile container.

FIG. 5a is a flowchart illustrating how the container ensures the presence of all peripheral items.

FIG. 5b is a flow chart illustrating how the container identifies the peripheral items.

FIG. 6 is diagram exemplifying a use case of the methodology.

FIG. 7 is diagram exemplifying another use case of the methodology.

FIG. 8 is a table listing mobile containers for which this invention can be applied.

### DETAILED DESCRIPTION OF THE INVENTION

As previously described, inventory and peripheral tracking management has been limited to macro cases. Secondly, the aforementioned systems require an in-house server or database. Thirdly, personal tracking solutions face many limitations: (1) they are not inclusive to an enclosed boundary, making it difficult to track items with certainty within a container; (2) their efficacy is limited by the adoption rate of the technology outside a user's personal space; (3) they require active user input and/or management; and (4) they are too bulky and visible for smaller, personal items, such as lipstick.

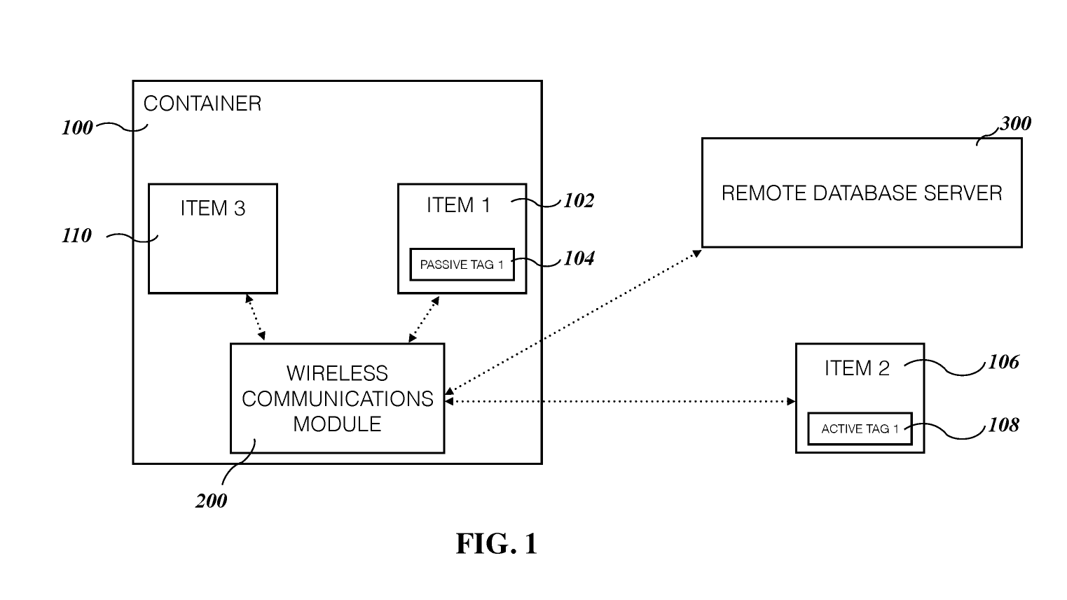

One solution is a method for inventory tracking using peripheral identification within a mobile container. Referring to FIG. 1, such a system is comprised of a device coupled with a mobile container, peripheral items, and a remote database server. The container 100 communicates with the peripheral items 102, 106, and 110 and the server 300 via a wireless communications module 200 present within the device. Upon a signal input, the communications module commences a “peripheral check,” or query of the peripheral items for their identity tokens. The communications module can query items tagged with passive electronic tags 104 and/or active electronic tags 108, as well as items embedded with wireless identification and communications capabilities 110 such as Bluetooth, 4G/5G, or WiFi. The system then transmits the item identifier tokens to a remote database server 300 where they can be identified and matched to a physical object. If the item is outside the container, the communications module may not capture its identifier token and thus be unable to match it within the database. If the item is listed on the database for the container, the absence of its identifier token would cause the system to issue an alert message. In this example, upon peripheral check the system would return that item 106 is missing.

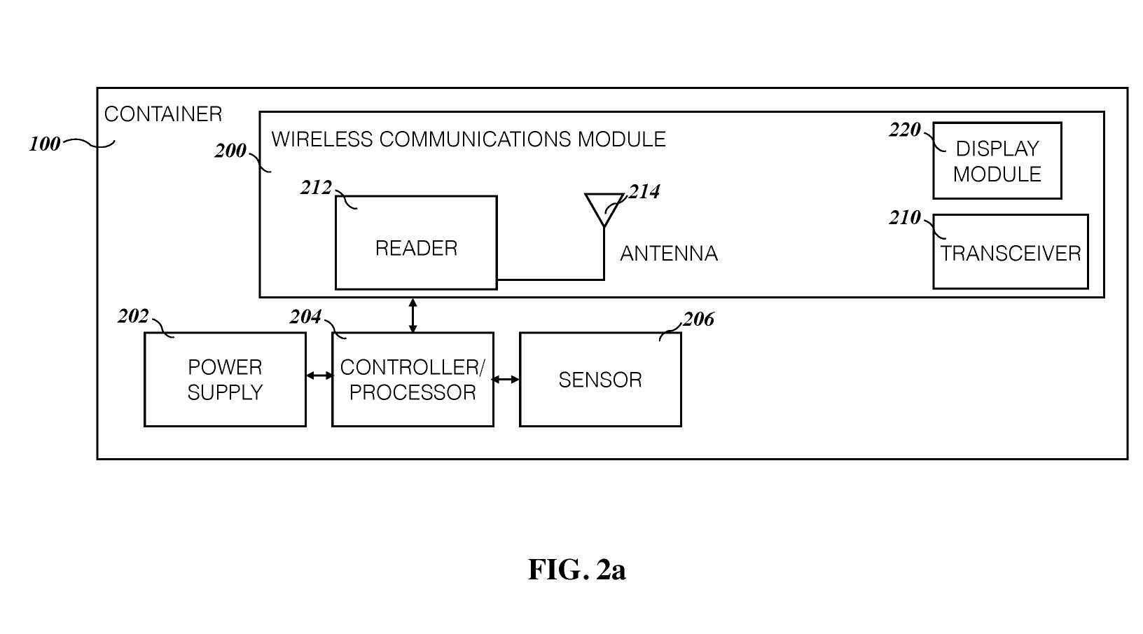

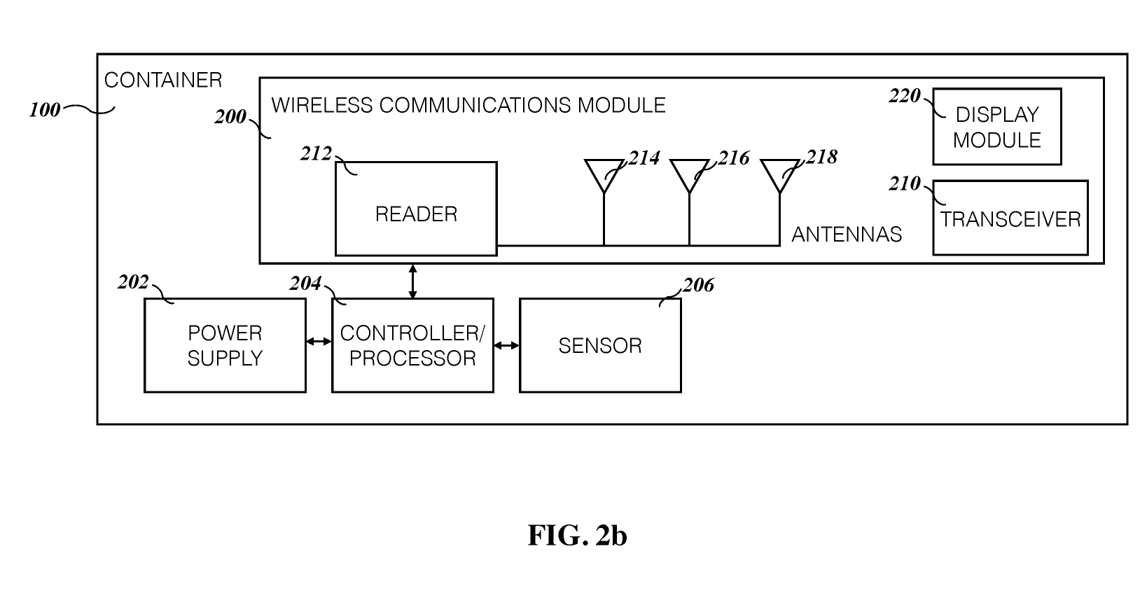

Referring to FIG. 2a, the device itself is comprised of a power supply 202, controller 204, sensor 206, and communications module 200. The power supply can be any power solution suitable to provide enough power to the wireless communications module to query the peripheral items and communicate the information to the remote server. A larger mobile container, such as an aircraft, querying items over longer distances may need a larger power supply. A smaller container, like a backpack, may only need a small battery to drive electrical energy to the system. The controller may be a CPU, MPU, or MCU, and processes information sent and received via any and all integrated technologies. It can be used to package the information collected by the wireless communications module after a peripheral check in a form that can be transmitted by the transceiver 210 or in some embodiments, by a mobile device (not expressly shown), to the server. Specifically, it sends control commands to the reader 212 and receives tag data from the reader. The sensor may be any device that detects events or changes in the physical environment. For example, the sensor may be an electronic switch or lock, detecting open and close events within the container. In an always-closed container, the interruption of sensor activity may also trigger a signal input that initiates a peripheral check. In a particular embodiment, the sensor may be a motion detection technology such as a multi-axis accelerometer measuring the proper acceleration of the container, and may also act as a signal input for the system to query the peripheral items. In other embodiments, the signal input may originate from a human-computer interface, such as from a digital button pressed by the user for an on-demand query of the container' s contents. In this case, the query message originates from the remote database server, which in turn uses the communication network to transmit the command to the device.

The sensor introduces the presence of “gates” or conditions that must be met before the system activates the peripheral check and queries the items. This enables the system to remain in hibernation or sleep mode until necessary, which not only preserves battery life but also allows for the peripheral checks to be more accurate thanks to a multi-check system. In this way, the system is not always pinging for the presence of items, as is the case with previous solutions, but instead only when it is absolutely necessary to do so, without user intervention.

The communications module 200 is comprised of a network transceiver 210, a reader-antenna system 212-214 that reads information from electronic tags on peripheral items, and a display module 220 that presents resultant information. The transceiver bi-directionally communicates with the controller and database on a remote server to determine the identity of the peripheral items as well their presence status after a signal input is received by the system due to the sensor. In some embodiments, it is responsible for all outgoing and incoming information from and to the system. In other embodiments, a mobile device may transmit information between the container and the server, acting as an intermediary between the two. The transceiver can be any form of wireless communications technology such as Bluetooth, 4G/5G or other cellular networks, WiFi or other WANs, and other newer wireless communication means such as Internet area networks (IAN) and near-me area networks (NAN). In a particular embodiment, the transceiver uses Bluetooth LE to communicate with a mobile device, which then uses its embedded 4G/5G or WiFi transceiver to communicate with the remote server. In some embodiments, the transceiver may be used to communicate with and identify the items that are embedded with an identifying technology other than RFID.

The reader-antenna system act together to query the peripheral items for identifier tokens. In a particular embodiment, the reader 212 may be an active RFID reader. RFID is exceptionally beneficial for tracking and identifying items within a mobile container when used with closer-range frequencies such as HF (13.56 MHz) or with higher-range frequencies such as UHF (860-960 MHz) in low-power mode, as compared to Bluetooth, which has a high uncertainty radius and can communicate up to 100 feet away. The reader uses the attached antenna 214 to capture data from the electronic tags of the peripheral items upon a signal input, in a particular embodiment from a multi-axis accelerometer. Depending on the size of the container, the the reader may need multiple antennas to query the peripheral items, as shown in FIG. 2b. Multiple antennas would also be necessary for the RF to more effectively reach the items whose tags or communication cores may be blocked or obstructed for various reasons, such as would be the case when liquids or multiple objects are present.

After being triggered by a signal input from a sensor, the reader-antenna system queries items for identifier tokens. The items may be tagged with passive RFID tags 104 or active RFID tags 108, or can innately communicate their identities to the container 110, such as may be the case if the item is a mobile device, headphones, a computer mouse, car keys, or another embedded object, which uses either Bluetooth, an internally embedded RFID, or other identifying methods to communicate its identity. In some embodiments, the reader may be tuned to operate on a specific frequency range to query a specific group or type of items embedded with wireless identification and communication technologies.

The received identifier tokens are then transmitted to the controller via the antennas to be converted into packets of information that can be sent to the database on the remote server via the transceiver. Those skilled in the art of RFID reader-antenna systems can understand and appreciate the method by which identifier tokens are received via electronic tags. The reader-antenna system converts electrical current into radiating electromagnetic waves that can be received by the tags and be re-converted into electrical current, which in turn then re-convert the electrical current into electromagnetic waves. These waves can then be propagated back and received by the reader-antenna system, which then finally convert the waves into a readable electrical current. Thus, when referring to an identifier token, the invention refers to a packet of electrically encoded data. Aside from use in querying the peripheral items, this process is also used by the reader-antenna system to encode particular tags so as to update the database or revise the record to alter the association and disassociation of items to the container.

Coupled with the transceiver, the display module 220 acts to generate, transmit, and present the information resulting from the actions completed by the device. In some embodiments, the display module can be a mobile device not necessarily integrated into the device but coupled with the transceiver via a communications network (not expressly shown). In other embodiments, the display module can be a sensory indicator providing, aside from visual feedback, aural or haptic feedback, and in some instances where applicable, gustatory or olfactory feedback (not expressly shown).

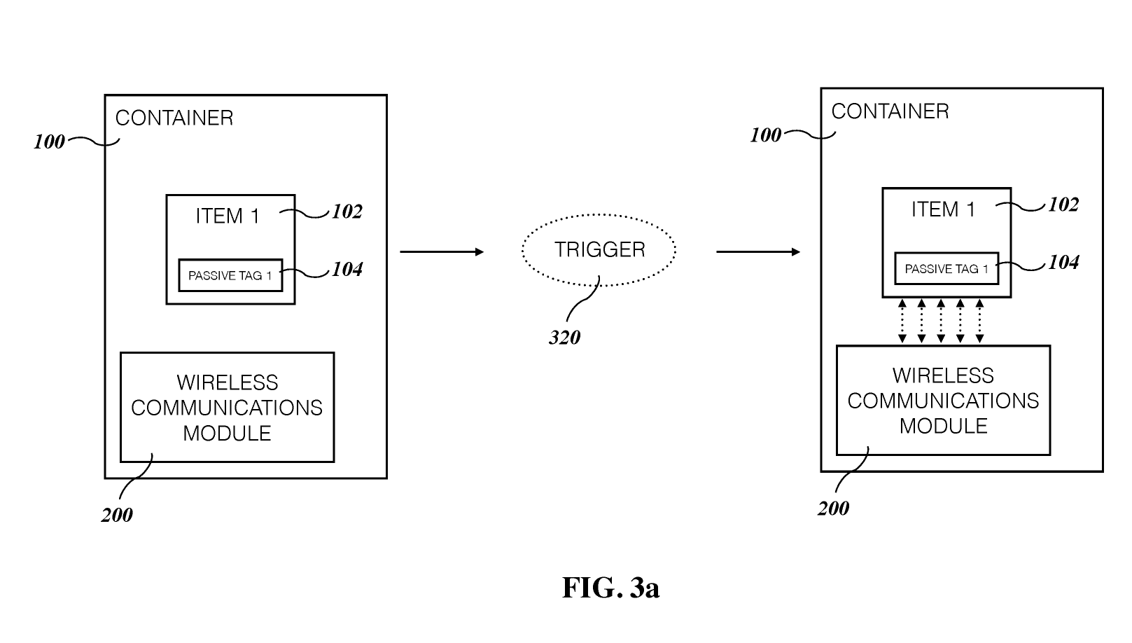

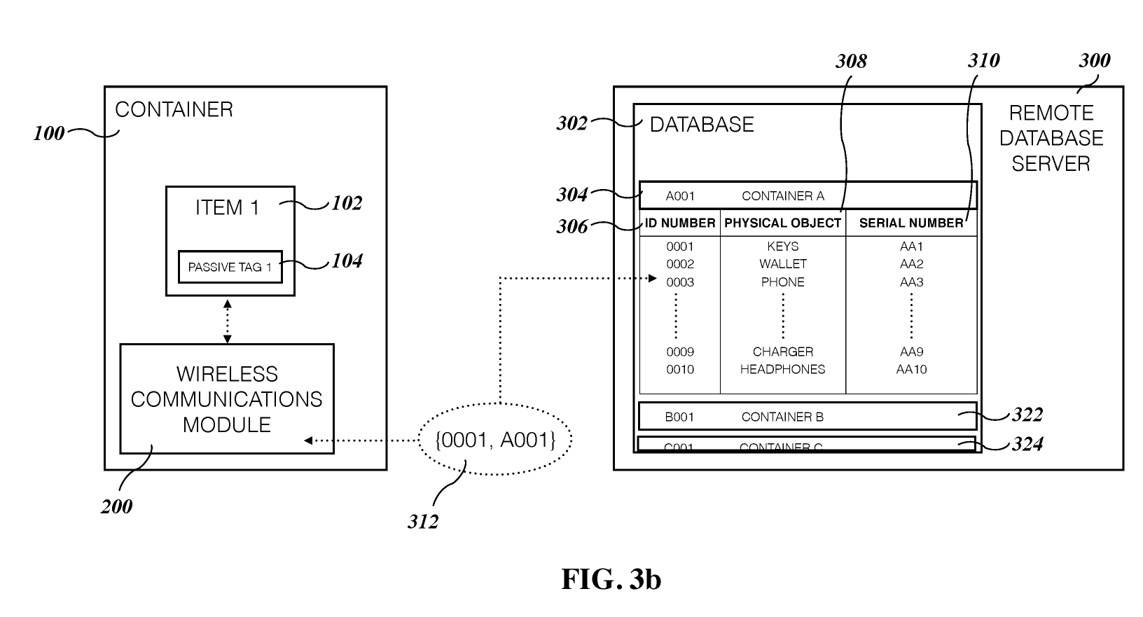

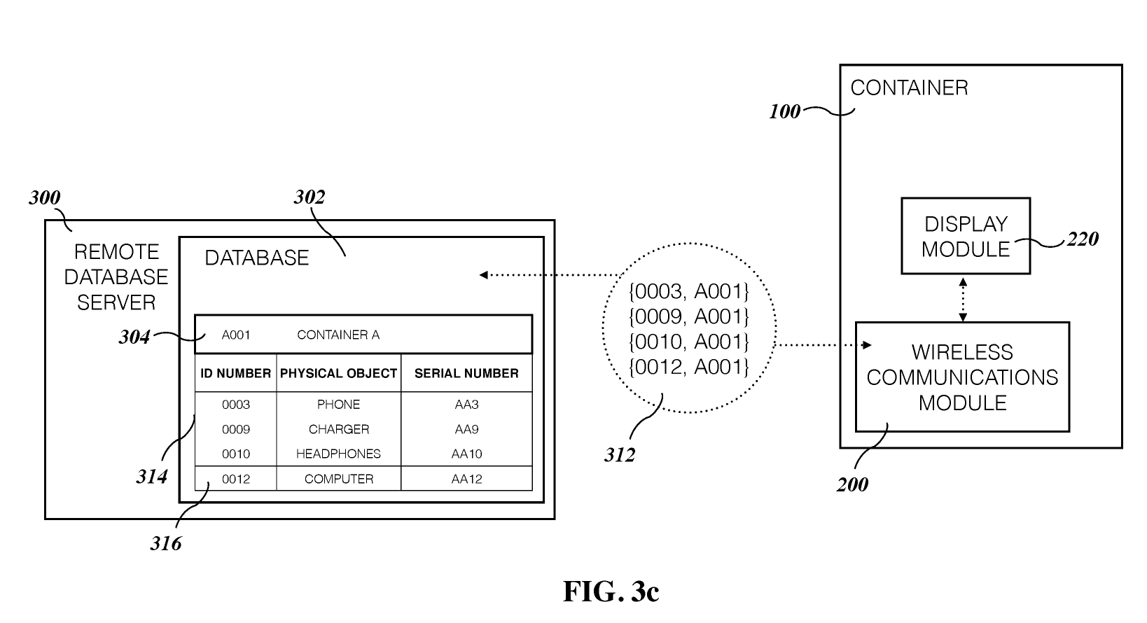

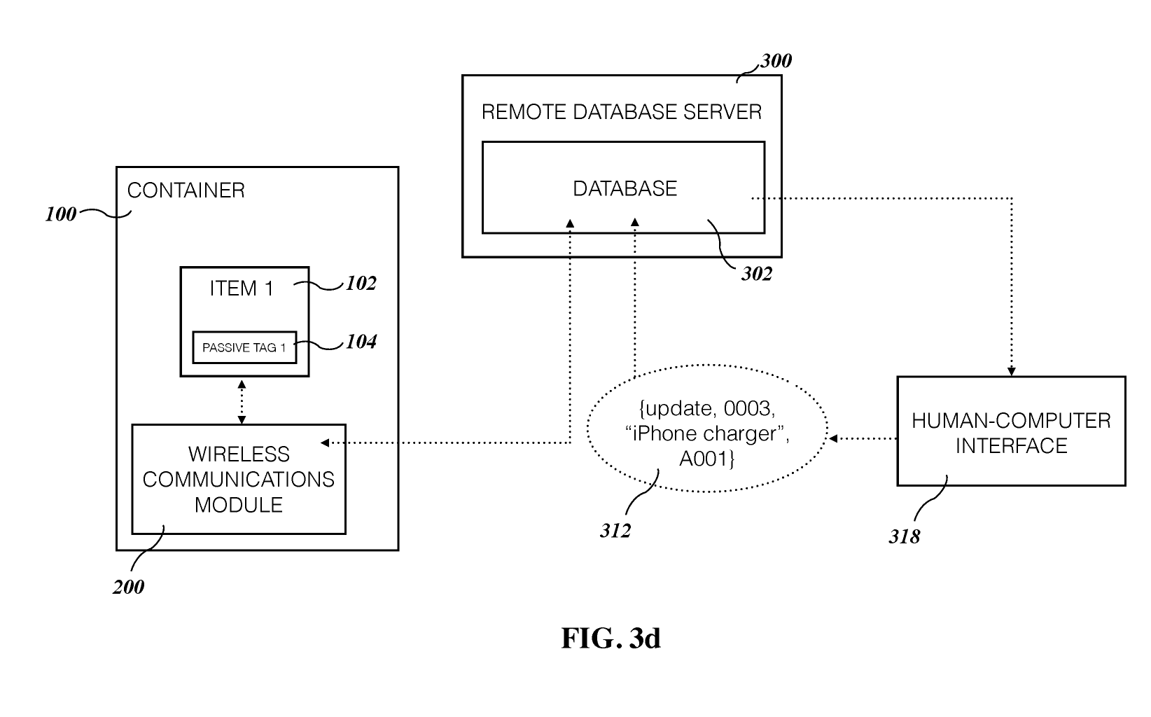

Referring to FIG. 3a, a mobile container 100 holds an item 102 tagged with a passive RFID tag 104. There is no communication between the device and the item within the container's cavity. Upon a trigger 320, the wireless communications module receives a signal input (not expressly shown) to initiate a peripheral check. By way of the integrated reader-antenna system 212-214, item 102 is queried for its identifier token.

The identifier token 312 is received by the wireless communications module and transmitted from the device to a database 302 on the remote server 300 (FIG. 3b). The identifier token may be an ID number or alphanumeric ID 306 that is used to associate the item to a physical object 308, product serial number 310, or other information. In some embodiments, a container identifier 304 may accompany the identifier token. The container identifier may be used to facilitate the association and disassociation of items to the specific or other containers by updates to the database record via a communications network or human-computer interface. In this particular example, identifier token 312 of item 102 is passed to the remote database server 300 along with the container identifier 304. The identifier token includes the item's ID number 306, which when matched to a physical object 308 on the database 302, identifies the object as “Keys.” The container identifier 304 identifies the container as “Container A.” According to the database record 302, there are ten items associated to Container A.

By crosschecking the identifier tokens with the entries associated to Container A on the database record, the system can determine whether items are missing from the container. Because no other identifier token was transmitted, the system will issue an alert message via the communications network (not expressly shown). In this example, nine items would be reported missing. Similarly, referring to FIG. 3b, in the case where the identifier token 312 does not match an entry on the database 302, the database would return an alert to the display module 220 via the communications network (not expressly shown). The absence of a match on the database, whether due to the absence of an identifier token (missing item) or the presence of an unlisted identifier token (unregistered item), forms the basis of logic for the peripheral identification method. The database can hold many records associated with different container identifiers, in the same way the server can hold multiple databases 322, 324 (FIG. 3b).

The database may be used to store any and all information regarding the device, including but not limited to, a user's behavioral information, item associations and disassociations, container inventory at any point, and other activities or occurrences with respect to items and the container without the limitation of local storage. This information is available to the database and captured via peripheral checks, as well as updates and revisions to the database record. The updates and revisions can be implemented via a communications network, such as communications module 200 or human-computer interface 318 (FIG. 3d). The information can be used in the development of predictive algorithms that generate recommendations for intelligent inventory management.

In some embodiments, such a predictive algorithm may be applied to the database to enable the auto-generation of specific contents lists against which the container may monitor the presence (or lack thereof) of its contents. Referring to FIG. 3c, the algorithm may suggest that an item with ID number 0012 and physical description “Computer” be carried by Container A, and thereby update the current record 314 with a new entry 316. The updated contents list, or other resultant information, may be transferred from the server to the container via an identifier token 312 and be received by the wireless communications module 200. The contents list may be visually rendered by the display module 220 or in some embodiments by a mobile device, after being transmitted by the wireless communications module 220.

The database 302 may be actively updated by transmitting a command via a human-computer interface 318 (FIG. 3d). The command may generate an identifier token 312 with specific instructions to update item 102 with ID number 0003 in the database from the physical identifier 308 of “Phone” to “iPhone charger” within Container A. The database may receive the identifier token via any communications means linked with the human-computer interface and transmit the information to the container via the wireless communications module 200, where the embedded reader-antenna system 212-214 may encode (rewrite) the item's tag 104 with the new information. After this is complete, the device would resend the newly encoded information back to the database on the remote server 300 via the embedded transceiver 210. The remote server would then transmit the new information to the human-computer interface via the communications network where it may be rendered accordingly.

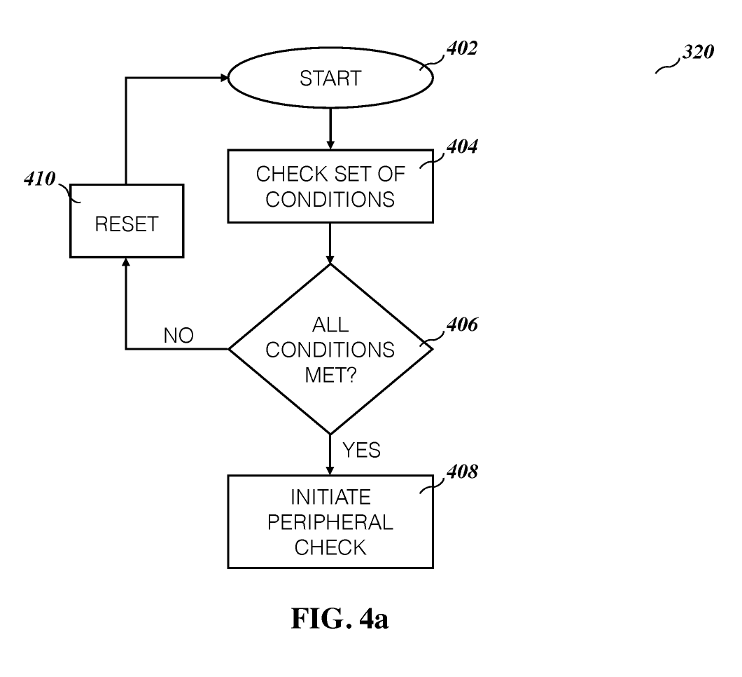

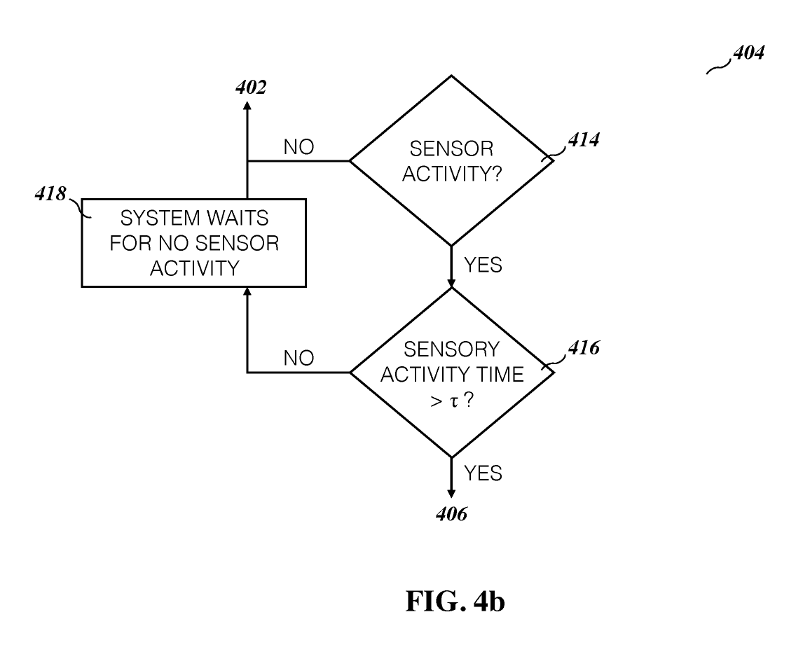

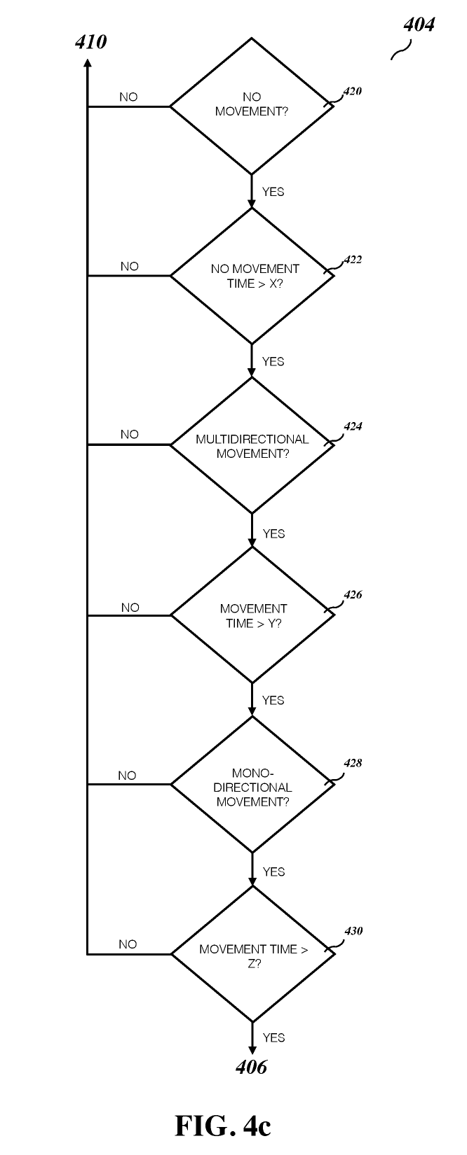

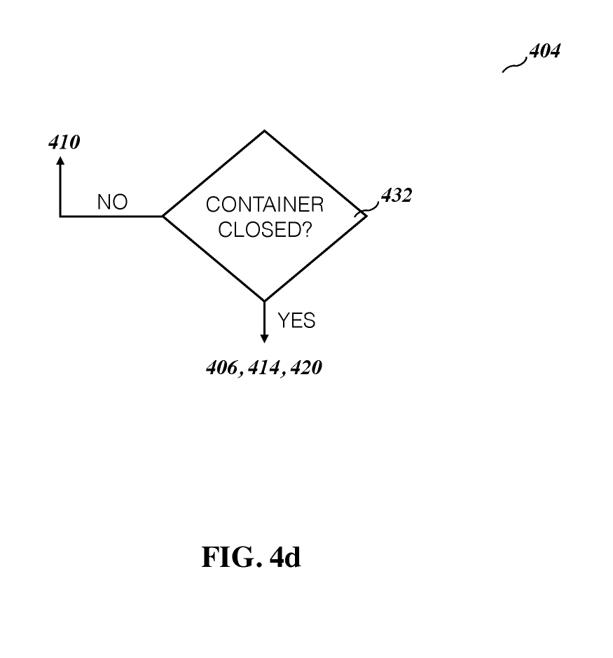

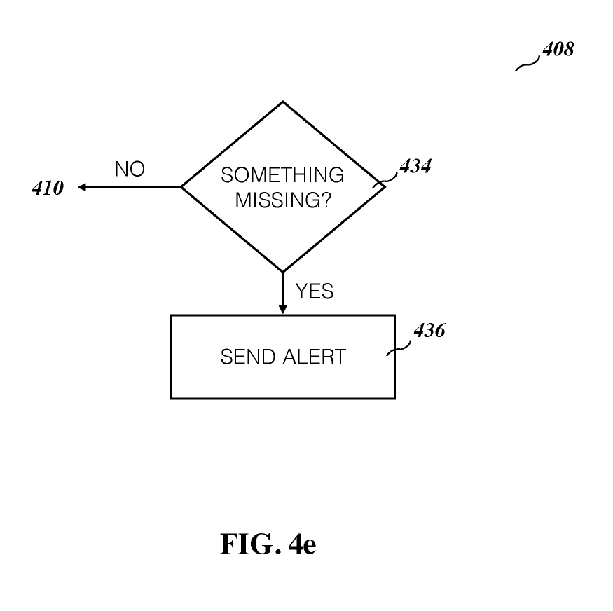

FIG. 4a is a flowchart illustrating the methodology for a peripheral check to be triggered 320 within in a mobile container, according to some embodiments. A series of conditions 404 must be met before a signal input 406 triggers the system to initiate peripheral check 408. If the conditions are not met, the system will reset 410 and initiate the sequence again. The conditions that must be met depend on the type of sensor 206. An example of conditions that must be met before a peripheral check is initiated is that the container must detect sensor activity for a predetermined amount of time (FIG. 4b). The embedded software begins a timer as soon as the sensor registers any activity. If the sensor activity time reaches the predetermined threshold, the system will check if there are any other conditions that need to be met 406 before initiating a peripheral check 408. If the system does not register sensor activity, then the system simply restarts 402, without moving onto subsequent conditions. If the system registers sensor activity but the time value of the activity is less than the preset threshold value, the system will reset after no activity is once again registered 418. This prevents the system from logging false positive time values greater than the preset threshold value by forcing the timer to reset.

In some embodiments, the sensor may be a multi-axis accelerometer registering various types of movement before a peripheral check may be initiated. A specific sequence of conditions that must be met by the system as registered by the sensor is illustrated in FIG. 4c. In this sequence, if several timed conditions for no movement, multidirectional movement, and mono-directional movement are not met, the system will reset. Multi-step conditions like these are useful for mirroring user behavior and intelligently applying peripheral checks. For example, the behavior of a user carrying a backpack and leaving a café would be modeled similarly to FIG. 4c. Initially, the backpack would be static, only to be ruffled when the user puts her objects back into the container. As the user leaves, the backpack would be moving in the same direction as the user. In this instance, the use of a peripheral check to identify if all associated items are present in the backpack container would be incredibly useful.

Having multiple sensor conditions enhances the intelligence of the system further. The need for a container to be closed before checking for other conditions, for example, could be layered in to prevent additional false-positives (FIG. 4d) and further acts to conserve the power of the system.

If all conditions have been met 406, the system will initiate a peripheral check 408 and determine whether an item is missing 434. As previously described, the system will query the peripheral items for identifier tokens which are then matched to a database on a remote server. The resultant information will be transmitted to the display module or associated mobile device of the container. If there are no missing peripherals, the system resets 410 and hibernates until a condition awakes it once again, such as the registration of sensor activity for a predetermined amount of time. If a peripheral item is determined missing due to the absence of an identifier token match on the database, the transceiver will transfer an alert 436 to the display module 220 or mobile device (FIG. 4e).

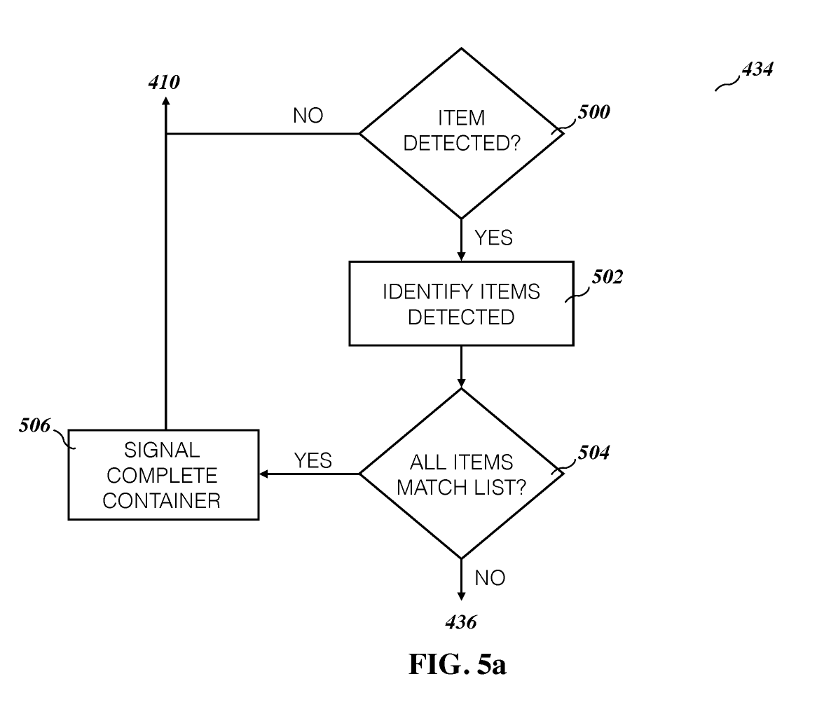

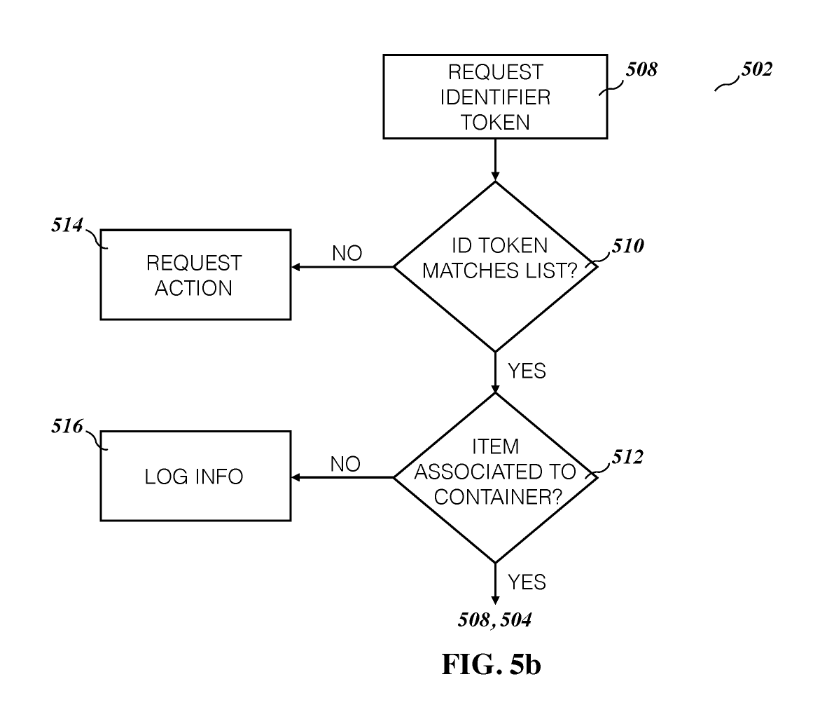

FIG. 5a is a flowchart illustrating how the container ensures the presence of all peripheral items with which it is associated, according to some embodiments. The reader-antenna system 212-214 (and in some embodiments the transceiver 210) first detect whether a connection can be made with a peripheral item 500. After identifying the items 502, the device cross-checks the database record 302 on the remote database server 300 to ensure all peripherals are present 504. If all associated items are present, the server communicates to the transceiver indicating the container is complete 506. In some embodiments, this signal may be communicated to the display module 220. The system then resets and hibernates until a signal input is received and awakes it once again 410. If a peripheral item is determined missing due to the absence of an identifier token, the server will communicate to the transceiver that the container is incomplete 436. If a connection cannot be made between the wireless communications module 200 and an item, the system will reset 410 and hibernate until a signal input awakes it once again.

FIG. 5b is a flowchart illustrating how the container identifies the peripheral items, according to some embodiments. After having searched for and detected peripheral items 500 using reader-antenna system 212-214 (and in some embodiments the transceiver 210), the system queries and receives an identifier token from each peripheral item (either through its tag or embedded identification technology) 508 and cross-checks it with the database of associated items 510 stored on a remote server. The database of all items can be accessed via the wireless communications module 200 or mobile device, depending on the embodiment. The system will first determine whether the identifier token is a match to an entry on the database 510 before determining whether the item is associated with the container via the container identifier 512. The system will cycle through the identification cycle until all items are identified and recognized as associated 504. If the system detects the presence of an unlisted identifier token (i.e. an unregistered item), the system will request an action 514. In this embodiment, the system would ask the user to register the item, add it to a list, or both. If the system detects an identifier token that is associated with another container identifier 512, the system will log the information 516 on the current database as well as appropriate database record of the correct container for future use. As previously described, the system may log other information to the database such as which items are currently in the container, the frequency of this occurrence, and other information relating to activities or occurrences with respect to items and the container. The logged data may be analyzed and parsed into pre-generated lists for various activities. For example, if user carries a specific set items on the weekends, then over time the container would create a list for that activity and automatically check for those items, absent any user involvement. The peripherals lists may be stored on the server to be peripherally checked by the system according to the aforementioned embodiments or on-demand by the user in other embodiments.

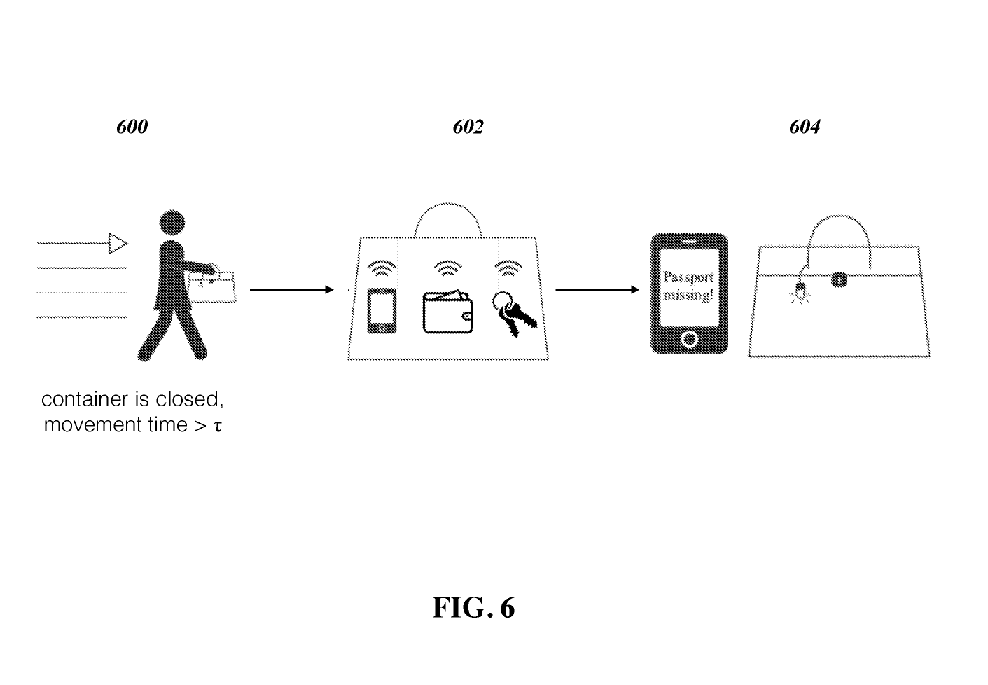

As previously described, the database record may be updated and revised, in some embodiments, via a human-computer interface 318. Such updates and revisions would enable the association or disassociation of items to the container, and in some embodiments, a user-generated contents list customized for activities or the mobile container. As an example, assume the mobile container is a handbag (FIG. 6). A list generated by the user may be keys, wallet, passport and phone. The items may be placed within the bag prior to travel. The bag may be closed, picked up, and carried by the user toward a destination 600. After the sensors, such as a switch and motion sensor, meet a combination of conditions over a predetermined amount of time, a peripheral check may be initiated 602. If there is an item missing from the list, a message may be sent to the user's mobile device and to an external indicator integrated into the bag 604.

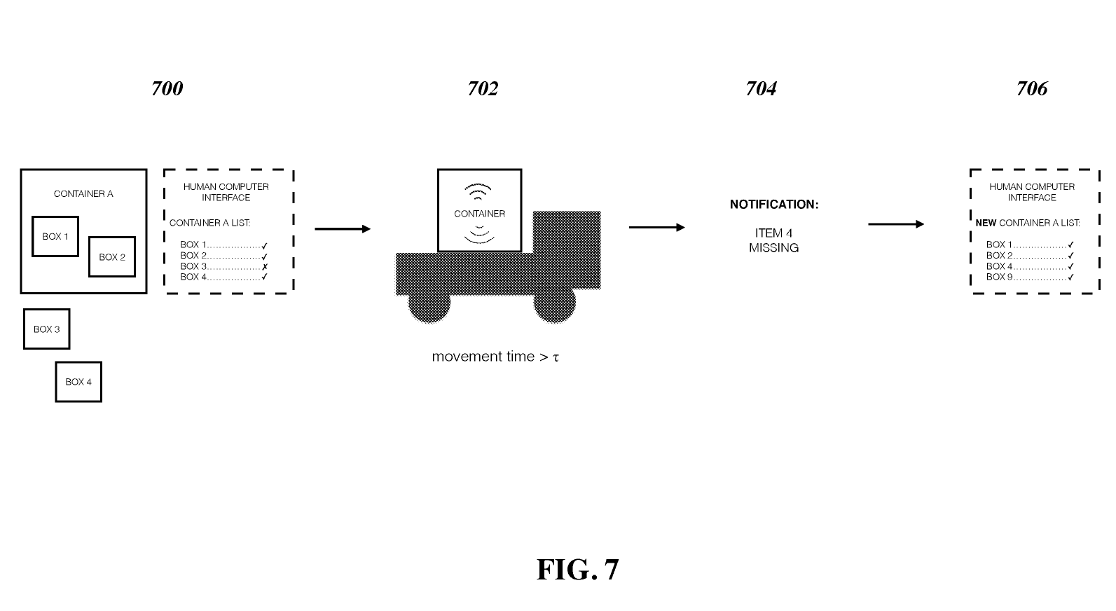

In some embodiments, the database may be preloaded with information from previous associations. Assume the mobile container is a shipping container (FIG. 7). Having been used for a specific route, a container may have be associated with specific items such as Boxes 1, 2, 3, and 4. In the case that the container's associated contents list may need to be updated, a user may disassociate an item from the container 700 via a human-computer interface 318. After the container is loaded onto a truck and after a set of sensor conditions such as movement are met over a predetermined amount of time, the system may trigger a check 702. If a box is missing from the container, a message may be delivered to the dispatch shipping team's display monitor and to the truck driver's mobile device 704. Over time, the system may automatically generate a new list for the specific route with the associated items 706 without any user involvement or intervention. This can also be done by accessing and syncing to an external database, such as a calendar, to anticipate the carrying needs of the container.

In other embodiments, the database may be preloaded with information from other similar containers. As another example, assume the mobile container is a new car. The new car's database may include a list of items from a user's previous travels as well as others' cars. A list of tagged items that a user may need for vehicle safety such as a spare tire, jumper cables, flashlight, reflective triangle, and seatbelt cutter. Upon ignition, a peripheral check may be initiated. If there is an item missing from the list, a message may be sent to the car's infotainment system and to the user's mobile device.

As yet another example, assume the mobile container is a celestial body. A list of tagged items may be people. An external user on a space station, for example, manually initiates the peripheral check via a human-computer interface. If there are people missing, a message may be sent to the space station's command center.

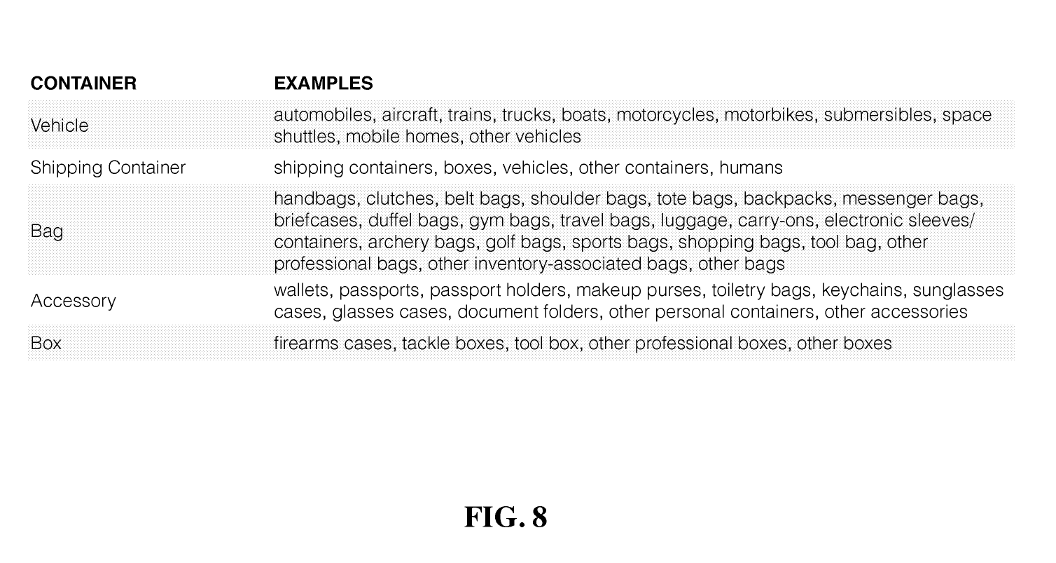

FIG. 8 is a table listing mobile containers for which this invention can be applied.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What I claim is:

1. In a communications network comprising a mobile container bi-directionally communicatively coupled with a remote database server, a method comprising:
a. providing a device coupled with the mobile container, the device comprising:
i. a network transceiver adapted to bi-directionally communicate with the remote database server;
ii. an internal communication means adapted to detect and read information from at least one electronic tag;
iii. a sensor; and
iv. a trigger means communicatively coupled with the network transceiver, the sensor and the internal communication means, and the trigger means adapted to cause the internal communication means to receive information from the at least one electronic tag in response to a signal input received from the sensor; and
b. transmitting information received by the internal communication means from the at least on electronic tag to the remote database server.

2. The method of claim 1, wherein the internal communication means comprises a wireless communications receiver adapted to receive the information from the at least one electronic tag.

3. The method of claim 1, wherein the internal communication means comprises an active reader adapted to receive the information from the at least one electronic tag.

4. The method of claim 1, further comprising an identification data of the at least one electronic tag, whereby the at least one electronic tag is related to at least one database record of the remote server.

5. The method of claim 1, further comprising a provision of an identifier token from the at least one electronic tag to the internal communication means.

6. The method of claim 5, further comprising a transmission of the identifier token from the device to the remote server.

7. The method of claim 1, further comprising a provision of an identifier token from the at least one electronic tag to the internal communication means, whereby the at least one electronic tag is related to a database record of the remote server.

8. The method of claim 7, further comprising a transmission of the identifier token from the device to the remote server.

9. The method of claim 7, further comprising accessing a database on the remote database server where at least one database record of the database references the identifier token.

10. The method of claim 9, wherein the at least one database record associates the identifier token with a type of physical object.

11. The method of claim 9, wherein the at least one database record associates the identifier token with a product serial number of a physical object

12. The method of claim 9, wherein the at least one database record associates the mobile container with a container identifier.

13. The method of claim 12, wherein the identifier token is transmitted from the device to the remote server in association with the container identifier.

14. The method of claim 12, further comprising issuing an alert message by the remote database server upon receipt of an alternate identifier token is transmitted from the device to the remote server in association with the container identifier in the instance that the alternate identifier token is not associated in the database with the container identifier.

15. The method of claim 4 further comprising writing additional information into the at least one database record of the remote server via the communications network.

16. The method of claim 15, wherein the additional information comprises user behavioral information.

17. The method of claim 1, wherein the trigger means comprises a trigger logic that polls the at least one electronic tag upon receipt by the container of a query message received via the communications network.

18. The method of claim 17, wherein the query message is originated at least in part from the remote database server.

19. The method of claim 1, further comprising applying a predictive algorithm to the information sent from the device and received by the remote database server, wherein the predictive algorithm generates an expected user behavior.

20. The method of claim 1, further comprising applying a predictive algorithm to the information sent from the device and received by the remote database server, wherein the predictive algorithm generates a recommendation to a user to include at least one object type within the container.

21. The method of claim 1, further comprising applying a predictive algorithm to the information sent from the device and received by the remote database server, wherein the predictive algorithm generates a recommended content list and the content list specifies at least one object type.

22. The method of claim 1, wherein the device further comprises a display module coupled with the network transceiver, and the method further comprises:
a. generating a resultant information by the application of the predictive algorithm to the information sent from the device and received by the remote database server;
b. transmitting the resultant information to the device; and
c. the display module of the device visually rendering at least a portion of the resultant information.

23. The method of claim 4, further comprising:
a. receipt by the remote database server of a command to update an informational content of the at least one database record; and
b. the remote database server associating or disassociating at least one item identifier with the device by revision of the at least one database record.
